(19) United States
(12) Patent Application Publication
(10) Pub. No.: US 2024/0190749 A1
(43) Pub. Date: Jun. 13, 2024

(54) MOLD FOR AN OPTICAL ELEMENT

(71) Applicant: OLYMPUS CORPORATION, Tokyo (JP)

(72) Inventor: Kenji KIKUCHI, Tokyo (JP)

(73) Assignee: OLYMPUS CORPORATION, Tokyo (JP)

(21) Appl. No.: 18/585,401

(22) Filed: Feb. 23, 2024

Related U.S. Application Data
(63) Continuation of application No. PCT/JP2021/037395, filed on Oct. 8, 2021.

(51) Int. Cl. C03B 11/08

(52) U.S. Cl. CPC C03B 11/08; C03B 2215/50

(57) ABSTRACT

A mold for an optical element includes: an upper mold including a first neck part; an upper-surface forming surface that is provided in a distal end of the first neck part of the upper mold, the upper-surface forming surface being configured to form an upper surface of the optical element; a lower mold including a second neck part; a lower-surface forming surface that is provided in a distal end of the second neck part of the lower mold, the lower-surface forming surface being configured to form a lower surface of the optical element; a side-surface mold having a hole into which the first neck part of the upper mold and the second neck part of the lower mold are inserted, a part of an inner surface of the hole being configured to form a side surface of the optical element; and a sleeve to accommodate these molds.

### CROSS-REFERENCE TO RELATED APPLICATION

This application is a continuation of International Application No. PCT/JP2021/037395, filed on Oct. 8, 2021, the entire contents of which are incorporated herein by reference.

### BACKGROUND

### 1. Technical Field

The present disclosure relates to a mold for an optical element.

### 2. Related Art

In molding an optical element made of glass, it is proposed that in addition to molding of upper and lower optical surfaces of the optical element, molding of an outer-diameter part of the optical element is also performed at the same time to omit an after mold centering process (for example, Japanese Patent No. 4549820).

In the method proposed in Japanese Patent No. 4549820, in order to make an upper and a lower molds coaxial, a sleeve whose inner circumference is formed linearly (without step) is used. The sleeve holds the molds and a side-surface mold that forms the outer-diameter part, or circumferential part, of the optical element. The side-surface mold exists as a different member from the upper and lower molds. The side-surface mold is positioned by fitting into the sleeve and clearances (gaps) are provided between the inner circumference of the side-surface mold and neck parts of the upper and lower molds. The neck parts are elongated parts projected from the upper mold main body and the lower mold main body, each of them having a surface at a distal end for forming each of optical surfaces of the optical elements.

### SUMMARY

In some embodiments, a mold for an optical element includes: an upper mold including a first neck part; an upper-surface forming surface that is provided in a distal end of the first neck part of the upper mold, the upper-surface forming surface being configured to form an upper surface of the optical element; a lower mold including a second neck part; a lower-surface forming surface that is provided in a distal end of the second neck part of the lower mold, the lower-surface forming surface being configured to form a lower surface of the optical element; a side-surface mold having a hole into which the first neck part of the upper mold and the second neck part of the lower mold are inserted, a part of an inner surface of the hole being configured to form a side surface of the optical element; and a sleeve in which the upper mold, the lower mold and the side-surface mold are housed, wherein a relationship in magnitude between a first clearance which is a clearance between the hole and the second neck part and a second clearance which is a clearance between the hole and the first neck part is determined according to a relationship in magnitude between a first distance which is a distance between a center of curvature of the lower-surface forming surface and an outer diameter height line and a second distance which is a distance between a center of curvature of the upper-surface forming surface and the outer diameter height line, wherein the outer diameter height line is defined as a line passing the side surface of the optical element to be molded at the half height of the side surface and orthogonal to direction of the hole. The side surface of the optical element is formed between an outer circumference of the upper-surface forming surface and an outer circumference of the lower-surface forming surface at molding, so the outer diameter height line runs just middle of the both outer circumferences. This disclosure is also understood as a disclosure of a method of design of mold for an optical element.

The above and other features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a schematic diagram illustrating an example of a configuration of a mold for an optical element according to an embodiment of the disclosure; and

FIG. 2 is an illustration for illustrating an outer-diameter deflection of the optical element.

### DETAILED DESCRIPTION

An embodiment of a mold for an optical element having an upper optical surface, a lower optical surface and side surface according to the disclosure will be described below with reference to the accompanying drawings. The disclosure is not limited to the following embodiment and the components of the following embodiment also contain ones that are replaceable or are easily replaced by those skilled in the art or ones that are substantially the same.

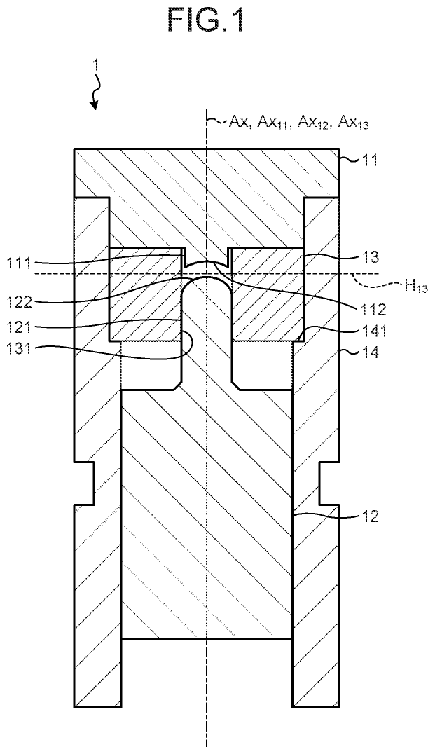

A structure of a mold 1 for an optical element according to the embodiment of the disclosure will be described with reference to FIG. 1. The mold 1 is a mold for molding, for example, an optical element made of glass. The optical element mold 1 includes an upper mold 11, a lower mold 12, a side-surface mold 13, and a sleeve 14.

The upper mold 11 includes a first neck part 111 that is cylindrical and that extends toward the lower mold 12. The first neck part 111 is a part that is inserted into a hole 131 of the side-surface mold 13 from an upper opening of the hole. An end part of the first neck part 111 is provided with an upper-surface forming surface 112 for forming an upper-side optical functional surface of the optical element. The upper mold 11 is placed on an upper end surface of the sleeve 14.

The lower mold 12 includes a second neck part 121 that is cylindrical and that extends toward the upper mold 11. The second neck part 121 is a part that is inserted into the hole 131 of the side-surface mold 13 from a lower opening of the hole. An end part of the neck part 121 is provided with a lower-surface forming surface 122 for forming a lower-side optical functional surface of the optical element.

The side-surface mold 13 is provided with the hole 131 that penetrates the side-surface mold 13 vertically. Part of an inner surface of the hole 131 is a side-surface forming surface for forming a side surface (outer-diameter part) of the optical element. In the embodiment, a straight line passing the side surface of the optical element to be molded at the half height of the side surface and orthogonal to a direction of the hole is defined as an “outer-diameter height line H₁₃”.

The upper mold 11 and the lower mold 12 are arranged in positions such that their mutual forming surfaces are opposed to each other with the side-surface mold 13 interposed in between. The upper mold 11, the lower mold 12, and the side-surface mold 13 are arranged inside the sleeve 14. The side-surface mold 13 is placed on a step 141 that is provided inside the sleeve 14.

The sleeve 14 is for housing the upper mold 11, the lower mold 12, and the side-surface mold 13 inside. The sleeve 14 is formed into a cylindrical shape. The step 141 for placing the side-surface mold 13 is formed inside the sleeve 14. Each of clearances of each of the parts forming the mold 1 for an optical element is set at approximately a few micrometers (μm) to few tens of μm.

When an optical element is molded with the mold 1, for example, as illustrated in FIG. 1, it is ideal that a center axis Ax₁₁ of the upper mold 11, a center axis Ax₁₂ of the lower mold 12, and a center axis Ax₁₃ of the hole of the side-surface mold 13 coincide, respectively. In the optical element that is molded in such an ideal state, an outer-diameter deflection of the optical element with respect to its optical axis Ax is zero. The optical axis Ax denotes a straight line connecting a center of curvature of the upper-surface forming surface 112 and a center of curvature of the lower-surface forming surface 122. The optical axis Ax penetrates at exact geometrical center of the optical element without a centering process.

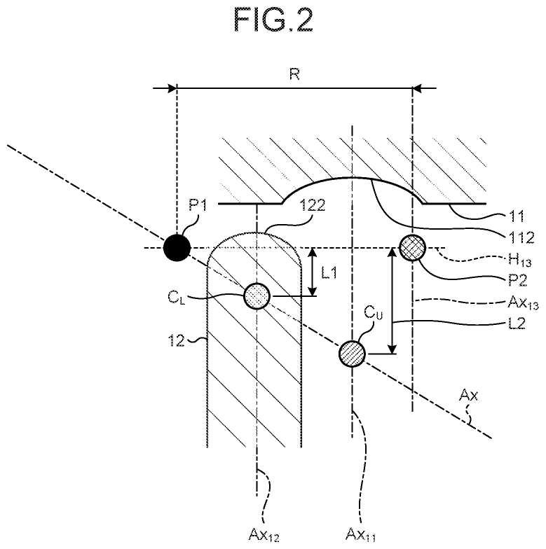

On the other hand, for example, as illustrated in FIG. 2, in molding an optical element with the mold 1, when the optical axis Ax connecting a center of curvature Cu of the upper-surface forming surface 112 and a center of curvature CL of the lower-surface forming surface 122 inclines with respect to the optical axis Ax at the ideal state, that is, the center axis Ax₁₁ of the upper mold 11 and the center axis Ax₁₂ of the lower mold 12 do not coincide, and the optical axis Ax inclines with respect to the center axis Ax₁₁ and the center axis Ax₁₂. In such a condition, an outer-diameter deflection R of the optical element at the outer-diameter height line H₁₃ increases. Note that, as illustrated in FIG. 2, the outer-diameter deflection R denotes a distance between a position P1 in which the outer-diameter height line H₁₃ and the optical axis Ax intersect and a position P2 in which the outer-diameter height line H₁₃ and the center axis Ax₁₃ of the hole of the side-surface mold 13 intersect.

Thus, in the mold 1 according to the embodiment, a relationship in magnitude between a distance (“first distance” below) L1 between the center of curvature CL of the lower-surface forming surface 122 and the outer-diameter height line H₁₃ and a distance (“second distance” below) L2 between the center of curvature Cu of the upper-surface forming surface 112 and the outer-diameter height line H₁₃ is focused on.

In the mold 1 according to the embodiment, a relationship in magnitude between a clearance (“first clearance” below) between the hole 131 of the side-surface mold 13 and the second neck part 121 of the lower mold 12 and a clearance (“second clearance” below) between the hole 131 of the side-surface mold 13 and the first neck part 111 of the upper mold 11 is determined according to the relationship in magnitude between the first distance L1 and the second distance L2. In other words, in the mold 1, the relationship in magnitude between the first clearance and the second clearance is set according to the relationship in magnitude between the first distance L1 and the second distance L2.

For example, as illustrated in FIG. 2, when the first distance L1 is smaller than the second distance L2, the first clearance is set smaller than the second clearance. In this case, for example, the first clearance is set at “3 μm at maximum” by setting “−2 μm to −1 μm” for a tolerance for a diameter of the second neck part 121 of the lower mold 12 and setting “0 μm to 1 μm” for a tolerance for an inner diameter of the hole 131 of the side-surface mold 13. The second clearance is set at “10 μm”.

On the other hand, contrary to the case in FIG. 2, when the first distance L1 is larger than the second distance L2, the first clearance is set larger than the second clearance. In this case, for example, the first clearance is set at “10 μm”. The second clearance is set at “3 μm at maximum”. As described above, the relationship in magnitude between the first clearance and the second clearance is the same as the relationship in magnitude between the first distance L1 and the second distance L2. By setting one of the first clearance and the second clearance smaller, the outer diameter deflection R is made smaller. The clearance which is set smaller is one having larger influence on making the outer diameter deflection R of the optical element with respect to the optical axis Ax small (it means choosing shorter one between the first distance and the second distance). By setting clearance of the other side relatively larger, in this side, interference between the neck part and the hole may be prevented or reduced. This can make the life of the mold longer.

In the optical element mold 1, a clearance (“third clearance” below) between an inner surface of the sleeve 14 and the upper mold 11 and the lower mold 12 is set smaller than a clearance (“fourth clearance” below) between the inner surface of the sleeve 14 and an outer circumference surface of the side-surface mold 13. In this case, for example, the third clearance is set at “a few μm” and the fourth clearance is set at “a few tens of μm”.

Note that the magnitude of the first and second clearances does not depend on the size (for example, the outer-diameter height) of the optical element to be molded. In other words, in the case where either an optical element in a large size or an optical element in a small size is formed, the magnitude of the first and second clearances is set according to the first and second distances. This makes it possible to reduce the outer-diameter deflection R of the optical element with respect to the optical axis Ax.

When a fine optical element having, for example, a diameter of approximately 5 millimeters is molded, however, compared to the case where a larger optical element is molded, the outer-diameter deflection R associated with a deviation of the center axis Ax₁₂ of the lower mold 12 with respect to the center axis Ax₁₁ of the upper mold 11 increases. For this reason, the method according to the embodiment is particularly effective in molding a small optical element. The method according to the embodiment is also particularly effective also in molding an optical element in which the distance between the centers of curvature of the upper and lower surfaces is short.

In the optical element mold 1 according to the embodiment described above, the clearances (the first clearance and the second clearance) respectively between the hole 131 of the side-surface mold 13 and the second neck part 121 of the lower mold 12 and between the hole 131 and the first neck part 111 of the upper mold 11 are set according to the distances (the first distance L1 and the second distance L2) respectively between the center of curvature CL of the lower-surface forming surface 122 and the outer-diameter height line H₁₃ and between the center of curvature Cu of the upper-surface forming surface 112 and the outer-diameter height line H₁₃. Accordingly, when molding an optical element, it is possible to keep the outer-diameter deflection R of the optical element with respect to the optical axis Ax small.

According to the mold for an optical element according to the disclosure, when molding an optical element, it is possible to keep the outer-diameter deflection of the optical element with respect to the optical axis small.

Additional advantages and modifications will readily occur to those skilled in the art. Therefore, the disclosure in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A mold for an optical element, comprising:
an upper mold including a first neck part;
an upper-surface forming surface that is provided in a distal end of the first neck part of the upper mold, the upper-surface forming surface being configured to form an upper surface of the optical element;
a lower mold including a second neck part;
a lower-surface forming surface that is provided in a distal end of the second neck part of the lower mold, the lower-surface forming surface being configured to form a lower surface of the optical element;
a side-surface mold having a hole into which the first neck part of the upper mold and the second neck part of the lower mold are inserted, a part of an inner surface of the hole being configured to form a side surface of the optical element; and
a sleeve in which the upper mold, the lower mold and the side-surface mold are housed,
wherein a relationship in magnitude between a first clearance which is a clearance between the hole and the second neck part and a second clearance which is a clearance between the hole and the first neck part is determined according to a relationship in magnitude between a first distance which is a distance between a center of curvature of the lower-surface forming surface and an outer diameter height line and a second distance which is a distance between a center of curvature of the upper-surface forming surface and the outer diameter height line,
wherein the outer diameter height line is defined as a line passing the side surface of the optical element at the half height of the side surface and orthogonal to a direction of the hole.

2. The mold according to claim 1, wherein the relationship in magnitude between the first clearance and the second clearance is a same as the relationship in magnitude between the first distance and the second distance.

3. The mold according claim 1, wherein a clearance between an inner surface of the sleeve and the upper mold and the lower mold is smaller than a clearance between the inner surface of the sleeve and the side-surface mold.
